(19) United States
(12) Patent Application Publication
(10) Pub. No.: US 2023/0070243 A1
(43) Pub. Date: Mar. 9, 2023

(54) SYSTEM AND METHOD FOR TEMPLATE MATCHING FOR NEURAL POPULATION PATTERN DETECTION

(71) Applicants: Ameer ABD ELHADI, Toronto (CA); Ciaran Brochan BANNON, Toronto (CA); Andreas MOSHOVOS, Toronto (CA); Hendrik STEENLAND, York (CA)

(72) Inventors: Ameer ABD ELHADI, Toronto (CA); Ciaran Brochan BANNON, Toronto (CA); Andreas MOSHOVOS, Toronto (CA); Hendrik STEENLAND, York (CA)

(21) Appl. No.: 17/869,280

(22) Filed: Jul. 20, 2022

Related U.S. Application Data
(60) Provisional application No. 63/230,333, filed on Aug. 6, 2021.

(51) Int. Cl. G06N 3/08; G06K 9/62

(52) U.S. Cl. CPC G06N 3/086; G06K 9/6201

(57) ABSTRACT

There is provided a system and method for template matching for neural population pattern detection. The method including: receiving neuron signal streams and serially associating a bit indicator with spikes from each neuron signal stream; serially determining a first summation (S1), a second summation (S2), and a third summation (S3) on the received neuron signals, the first summation including an element-wise multiply-sum using a time-dependent sliding indicator window on the received neuron signal streams and a template, the second summation including an accumulation using the time-dependent sliding indicator window, and the third summation including a sum of squares using the time-dependent sliding indicator window; and determining a correlation value associated with a match of the template with the received neural signal streams, the correlation value determined by combining the first summation, the second summation, and the third summation with predetermined constants associated with the template.

### TECHNICAL FIELD

The following relates, generally, to brain activity processing; and more particularly, to a system and method for template matching for neural population pattern detection.

### BACKGROUND

There are approximately 86 billion neurons in the human brain with trillions of connections. These neurons generate and transmit electrophysiological signals (action potentials) to communicate within and between brain regions. Various technologies, such as tungsten electrodes etched to a fine submicron tip, have enabled scientists to capture the activity of massive populations of neurons.

Patterns of activity in populations of neurons are considered to be key to understanding how the brain represents, reacts, and learns from the external environment. Populations of neurons replay patterns of activity in association with previous experiences during wakefulness, sleep, and intrinsically during field oscillations. During sleep, these patterns can recur at accelerated rates, and even in reverse order. The “memory” replay of these patterns can occur across various brain regions and in coordination. Analytic output from populations of neurons can effectively drive robotic limbs. Taken together, detecting patterns of neuronal populations is an effective means to explore and predict the brain.

### SUMMARY

In an aspect, there is provided a system for template matching for neural population pattern detection, the system in communication with a plurality of neural signal acquisition circuits, the system comprising one or more processors and one or more memory units in communication with the one or more processors, the one or more processors configured to execute: a signal interface to receive neuron signal streams from the neural signal acquisition circuits and serially associate a bit indicator with spikes from each neuron signal stream; a summation module to serially determine a first summation (S1), a second summation (S2), and a third summation (S3) on the received neuron signals, the first summation comprising an element-wise multiply-sum using a time-dependent sliding indicator window on the received neuron signal streams and a template, the second summation comprising an accumulation using the time-dependent sliding indicator window, and the third summation comprising a sum of squares using the time-dependent sliding indicator window; post-processing module to determine a Pearson's Correlation Coefficient (PCC) value associated with a match of the template with the received neural signal streams, the PCC value determined by combining the first summation, the second summation, and the third summation with predetermined constants associated with the template; and an output module to output the determined PCC value.

In a particular case of the system, the predetermined constants comprise: a first constant (C1) using a number of bins and the number of neuron signal streams; a second constant (C2) using binned indicators of the template summed over the number of bins and the number of neuron signal streams; and a third constant (C3) using a combination of binned indicators of the template summed over the number of bins and the number of neuron signal streams.

In another case of the system, the combination of the first summation, the second summation, and the third summation with the predetermined constants comprises a constant multiplier, a subtractor, a squarer, and a fractional divider.

In yet another case of the system, for each of the neuron signal streams, a binned value of the template is accumulated if an input spike indicator is active.

In yet another case of the system, the post-processing module comprises bit-serial arithmetic units that are cascaded to determine a squared PCC.

In yet another case of the system, the second summation comprises a count of all bit indicators in each time-dependent sliding indicator window.

In yet another case of the system, the third summation comprises partial sums of linear operations that are generated and accumulated as new values are received.

In another aspect, there is provided a computer-implemented method for template matching for neural population pattern detection, the method comprising: receiving neuron signal streams and serially associating a bit indicator with spikes from each neuron signal stream; serially determining a first summation (S1), a second summation (S2), and a third summation (S3) on the received neuron signals, the first summation comprising an element-wise multiply-sum using a time-dependent sliding indicator window on the received neuron signal streams and a template, the second summation comprising an accumulation using the time-dependent sliding indicator window, and the third summation comprising a sum of squares using the time-dependent sliding indicator window; determining a Pearson's Correlation Coefficient (PCC) value associated with a match of the template with the received neural signal streams, the PCC value determined by combining the first summation, the second summation, and the third summation with predetermined constants associated with the template; and outputting the determined PCC value.

In a particular case of the method, the predetermined constants comprise: a first constant (C1) using a number of bins and the number of neuron signal streams; a second constant (C2) using binned indicators of the template summed over the number of bins and the number of neuron signal streams; and a third constant (C3) using a combination of binned indicators of the template summed over the number of bins and the number of neuron signal streams.

In another case of the method, the combination of the first summation, the second summation, and the third summation with the predetermined constants comprises a constant multiplier, a subtractor, a squarer, and a fractional divider.

In yet another case of the method, for each of the neuron signal streams, a binned value of the template is accumulated if an input spike indicator is active.

In yet another case of the method, the post-processing module comprises bit-serial arithmetic units that are cascaded to determine a squared PCC.

In yet another case of the method, the second summation comprises a count of all bit indicators in each time-dependent sliding indicator window.

In yet another case of the method, the third summation comprises partial sums of linear operations that are generated and accumulated as new values are received.

In another aspect, there is provided a computer-implemented method for template matching for neural population pattern detection, the method comprising: receiving neuron signal streams and serially associating a bit indicator with spikes from each neuron signal stream; determining a correlation (e.g. Pearson's Correlation Coefficient (PCC)) value associated with a match of a template with the received neural signal streams using an artificial neural network trained using binary classification, the input to the artificial neural network comprising a window of the bit indicators, a loss function associated with the artificial neural network comprises a difference between a calculated correlation and an output of the artificial neural network; and outputting the determined correlation value.

In a particular case of the method, the artificial neural network matches to multiple templates, wherein the output of the artificial neural network comprises a T-dimensional vector, where each value in the vector corresponds to the correlation of the input window and T templates.

In another case of the method, the neuron spikes are binned before being inputted to the artificial neural network.

In another aspect, there is provided a processor-implemented method for template matching for neural population pattern detection, the method comprising: receiving neuron signal streams and serially associating a bit indicator with spikes from each neuron signal stream; determining a first summation (S1) on each of the received neuron signals and outputting the summations as a vector, the first summation comprising an element-wise multiply-sum using a time-dependent sliding indicator window on the received neuron signal streams and a template; determining a likelihood of a match of a template with the received neural signal streams using an artificial neural network, the input to the artificial neural network comprising the vector of first summations, where each vector acts as a perceptron of the artificial neural network, and is passed to further artificial neural network layers; and outputting the determined correlation value.

These and other aspects are contemplated and described herein. It will be appreciated that the foregoing summary sets out representative aspects of the system and method to assist skilled readers in understanding the following detailed description.

### DESCRIPTION OF THE DRAWINGS

A greater understanding of the embodiments will be had with reference to the Figures, in which:

FIG. 1 shows a block diagram of an embodiment of a system of template matching for neural population pattern detection, according to an embodiment;

FIG. 2 illustrates a diagram of an example of template matching, in accordance with the system of FIG. 1;

FIG. 3 illustrates an example of binning over a sliding-window on incoming indicator streams, in accordance with the system of FIG. 1;

FIG. 4 illustrates an example of input to template matching where indicators from multiple neurons are time-multiplexed over a single serial link, in accordance with the system of FIG. 1;

FIG. 5 illustrates an example of a hardware implementation of bit-serial indicators in accordance with the system of FIG. 1, where the bottom portion shows element-wise sample-template multiply-sum summation S₁, the middle-left portion shows summation S₂, the top-right portion shows the sum of sample squares of summation S₃, and the top-left portion shows control logic;

FIG. 6 illustrates an example of bit-level arithmetic units in accordance with the system of FIG. 1, where the top-right portion shows an adder, the top-left portion shows a subtractor, the middle portion shows a constant multiplier, and the bottom portion shows a squarer;

FIG. 7A shows a diagram of an example of a top-level hierarchy of the system of FIG. 1;

FIG. 7B shows a diagram for the post-processing module, in accordance with the system of FIG. 1;

FIG. 8 shows a diagram of an example of a decompression circuit, in accordance with the system of FIG. 1;

FIG. 9 shows a diagram for scaling a number of templates, in accordance with the system of FIG. 1;

FIG. 10 shows a diagram for scaling a number of neurons, in accordance with the system of FIG. 1;

FIG. 11 shows a bit-parallel pattern matching baseline model, in accordance with the system of FIG. 1;

FIG. 12 shows a diagram of an example of a configurable template matching architecture, in accordance with the system of FIG. 1;

FIG. 13 shows a diagram of an example of normalized template memory footprints of four configurations, in accordance with the system of FIG. 1;

FIG. 14 shows a flowchart for a method of template matching for neural population pattern detection, according to an embodiment; and

FIG. 15 illustrates an example implementation that benefits from an efficient implementation of S₁.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

Any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, solid-state drives, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

Patterns of activity in populations of neurons are thought to be key to understanding how the brain represents, reacts, and learns from the external environment. Populations of neurons replay patterns of activity in association with previous experiences. Advances in imaging and electrophysiology allow for the observation of activities of groups of neurons in real-time, with ever increasing detail. Detecting patterns over these activity streams is an effective means to explore the brain, and to detect memories, decisions, motivations, and perceptions in real-time while driving effectors such as robotic arms, memory retrieval or even augment brain function.

Template matching, as described herein, can be used to detect recurring patterns of neural activity. Dedicated hardware can reduce the time between raw data collection and transfer to processing neural patterns and can be used for reducing the form factor for neural-prosthetics. The present embodiments advantageously provide general-purpose, high-speed, flexible, template-matching hardware architectures that have broad applicability for imaging and electrophysiology in neuroscience applications.

Advantageously, embodiments of the present disclosure process incoming indicator streams in its native bit-serial form. It can use purpose-built bit-level processing units and a hardware efficient template encoding method to greatly reduce on-chip memory needs and to improve overall energy efficiency. An architecture for the present embodiments can keep pace with the incoming data rate and generate numerically identical results in real-time; thus advancing the type of applications that can be practically deployed. This is especially important for neuroprosthetic applications where the system needs to be portable. Example experiments conducted by the present inventors illustrate that the hardware-efficient approaches described herein are capable of processing real-time data while requiring minimal silicon area and power consumption.

Several technical problems are generally inherent for neuron-based brain machine interfaces. These include large-scale sampling of neuronal data, electrode bio-compatibility, real-time pre-processing and storage of the data, sorting neural spike activity, detecting neural patterns, and selecting the relevant patterns to drive a prosthetic device. Many recent attempts have been made to mitigate problems in electrode bio compatibility, including coatings, steering electrodes around vasculature, and the development of electrodes made from neural tissue itself, that grow into and interact with the brain. Attempts have been made in the calcium imaging domain to develop neural prosthesis, and these attempts require a degree of genetic manipulation. However, invasive imaging methods tend to have better long term signal stability and represent a practical potential for neuron detection in these applications.

The number of neurons that can be recorded simultaneously in live animals is rapidly increasing. Recent estimates range from 3,000 neurons when recording with electrophysiological signals and up to a million when recording from optical signals. Accordingly, there is a growing need for dedicated and accelerated algorithms and devices to process patterns of neural data fast enough for use in real-time applications. These approaches could detect memories, decisions, motivations, and perceptions in real-time while driving effectors such as robotic arms, memory retrieval or even augment brain function. For example, detection of repeated patterns of activity help predict the onset of a traumatic episode, before it is even experienced by the subject. After detection, a brain probe could be used to silence or rewire the relevant structures to alleviate the episode. However, most of these applications need to be untethered, where the device can be carried by the subject with a portable power source. Therefore, a small form factor and low power consumption are highly desirable.

Pattern matching is inherently challenging since a pattern is not an exact sequence of neuronal activity that repeats perfectly every time. Instead, pattern detection has to cope with inherently “noisy” neuron activity signals to assess patterns with some level of certainty. A range of approaches have been used to assess patterns of activity in populations of neurons and include; Bayesian decoding, recurrent artificial neural networks, explained variance, correlations of cell pairs and template matching with the Pearson's Correlation (PC) Coefficient (also referred to as ‘Template Matching’).

Template Matching determines a degree of match as PC coefficient generally ranges from 1 to −1 on a spectrum. Template Matching generally involves sliding a memory template along a stream of neural activities to find out when there is a sufficiently high correlation value to indicate a positive match between the template and the incoming neural activity. The minimum correlation value of a positive match can be determined experimentally for a specific template and application. The present inventors have found that correlation values of, for example, 0.4 or above can indicate a positive match. Template matching is applicable to both imaging and electrophysiology domains, has simplicity of algorithm, and has high matching success. However, prior art template matching approaches are computationally intense and require a desktop-class GPU or CPU for real-time applications. This problem will intensify as advances in probe technology enable sampling more neurons, especially for applications that require a portable solution.

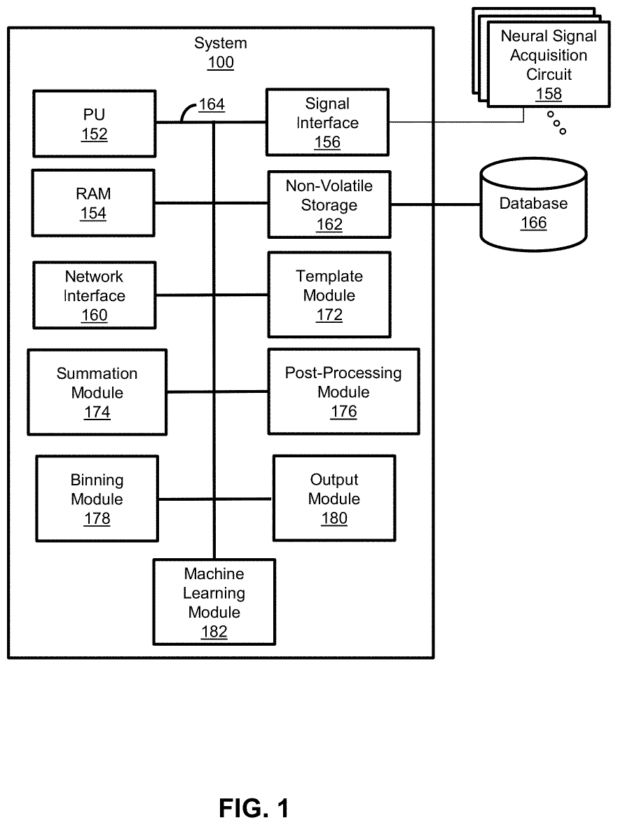

Turning to FIG. 1, a system of template matching for neural population pattern detection 100, according to an embodiment, is shown. FIG. 1 shows various physical and logical components of one or more embodiments of the system 100. As shown, the system 100 has a number of physical and logical components. It is understood that the system 100 and any of the modules described herein can be implemented in software, such as executed on a processing unit (“PU”) 152 (comprising one or more processors), or directly in hardware, as illustrated in the example circuit diagrams herein.

In the software embodiments, the system 100 includes random access memory (“RAM”) 154, a signal interface 156, a network interface 160, non-volatile storage 162, and a local bus 164 enabling PU 152 to communicate with the other components. PU 152 executes an operating system, and various modules, as described below in greater detail. RAM 154 provides relatively responsive volatile storage to PU 152. The signal interface 156 is in communication with one or more neural signal acquisition circuits 158 (for example, neuroprobes) to receive neuron signals, as described herein. The network interface 160 permits communication with a network, other computing devices and servers, or user devices. Non-volatile storage 162 stores code/instructions for executing the modules and functions. Additional stored data can be stored in a database 166. During operation of the system 100, the modules and the related data may be retrieved from the non-volatile storage 162 and placed in RAM 154 to facilitate execution.

In an embodiment, the system 100 further includes a number of conceptual modules to be executed on the PU 152 or directly in circuitry, including a template module 172, a summation module 174, a post-processing module 176, a binning module 178, and an output module 180. In further cases, the various modules can be combined, their functions can be run on other modules, or their functions can be run on other systems or devices.

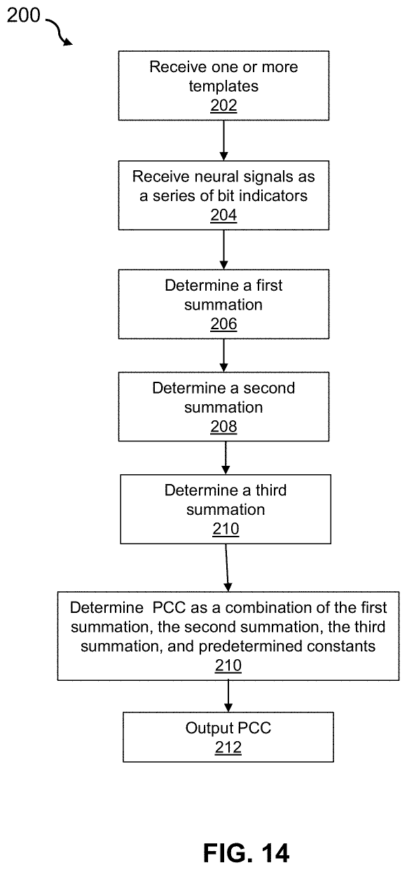

Turning to FIG. 14, shown is a computer-implemented method of template matching for neural population pattern detection 200, according to an embodiment and as described in greater detail herein. At block 202, one or more templates are received by the template module 172 from, for example, RAM 154, the database 166, or the network interface 160.

At block 204, the signal interface 156 receives neuron signals from the neural signal acquisition circuits 158 and serially associates a digital bit with spikes from each particular neuron signal circuit 158.

At block 206, the summation module 174 determines a first summation comprising an element-wise multiply-sum using a time-dependent sliding indicator window on the received neuron signals and a template. At block 208, the summation module 174 determines a second summation comprising an accumulation using the time-dependent sliding indicator window. At block 210, the summation module 174 determines a third summation comprising a sum of squares using the time-dependent sliding indicator window.

At block 212, the post-processing module 176 determines a Pearson's Correlation Coefficient (PCC) value associated with a match of the template with the received neural signals. The PCC value determined by combining the first summation, the second summation, and the third summation with predetermined constants associated with the template. The predetermined constants can be determined by the template module 172, or otherwise retrieved or received by the system 100 (for example, prior to run-time).

At block 214, the output module 180 outputs the determined PCC value to the network interface 160, to the RAM 154, to the database 166, or elsewhere.

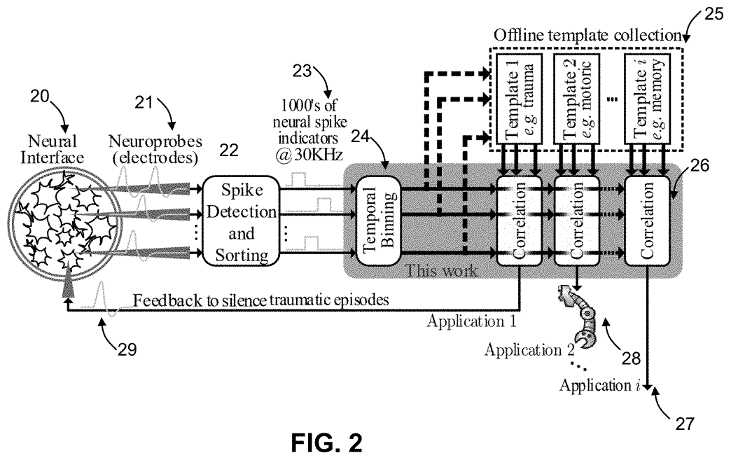

FIG. 2 illustrates a diagram of a high-level neural processing approach for pattern detection. Using neuroprobes 21, electrophysiological spikes of a living brain tissue 20 are continuously sampled and processed initially as analog signals. This spike detection and sorting stage 22 produces a time-ordered digital stream of binary indicators (0 or 1) 23. There is one indicator qn[t] per neuron n and per time step t. An example sampling rate of neural spikes is 30 KHz, resulting in a 30,000 bits/sec stream per neuron 23. Various applications (27, 28, and 29) can use neuroprobes capable of capturing the activity of many neurons. Pattern detection uses the observation that certain events of interest such as memories, decisions, or perceptions, manifest as patterns in the neuron stream. Informally, as FIG. 2 depicts, in these applications, patterns of interest have been pre-recorded 25 and are continuously compared 26 against the incoming indicator stream 23. This pattern matching process 26 generally uses some stochastic proximity metric. Advantageously, the present embodiments can be applied to applications (27, 28, and 29) where pattern matching occurs in real time.

Pattern detection uses the observation that certain events of interest such as memories, decisions, or perceptions, manifest as specific patterns in the neuron stream. Generally, as depicted in FIG. 2, patterns of interest are predetermined or pre-recorded 25 and can be continuously compared 26 against the incoming indicator stream 23. Naturally, this pattern matching process 26 is not precise and has to rely on some stochastic proximity metric. Applications for use of the system 100 can be applications (27, 28, and 29) where, for example, pattern matching occurs in real time. The output can be used to, for example, drive actuators such as robotic arms 28, or even to augment brain function. For example, detection of repeated patterns of activity may help predict the onset of an emotionally traumatic episode 29. If detection is quick enough, through closed-loop neural probe feedback 29, it may be possible to modulate the offending brain pattern to alleviate the episode. Accordingly, in some applications, a pattern detection latency of approximately 50 ms is desirable. This is defined as the time needed to detect the pattern once the last corresponding indicator in the input stream has been received. In the present disclosure, unless otherwise noted, the term latency refers to the pattern detection latency.

Generally, template matching involves sliding the incoming neuronal activity stream over a spatiotemporal template of activity indicators (a matrix corresponding to pre-recorded neural activity where rows correspond to neurons and columns to indicators over a period of time) to determine when there is a sufficient correlation. For clarity, it is assumed that there is only one template without loss of generality. When multiple patterns are desired, the approach can be performed independently for each one.

The system 100 accepts as input:
At the signal interface 156, N digital streams of spike indicators qₙ[t]: n ε {1 . . . N} each being a single bit denoting if a spike from neuron n occurred at time t, and
At the template module 172, a template matrix D ε B^{N×M} of N rows and M columns containing pre-recorded binary indicators with the time period of a template represented by M.

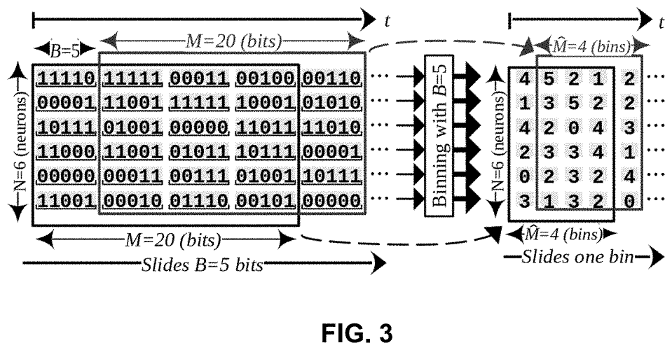

The typical sampling rate for input indicators is 30 KHz. However, the spiking rate of neurons is typically between 1 Hz and 20 Hz with a 1 KHz maximum. Using a much higher sampling rate of 30 KHz allows the system 100 to identify spike timing with precise temporal resolution for when spikes occur. As the indicator stream is noisy, every B indicators per neuron in the incoming stream and the template are “binned”, that is aggregated into a fixed point value of lg(B_{Eff}) bits. B_{Eff} B. binning is performed at runtime for the incoming stream, and off-line for the template D. FIG. 3 shows a short example of binning with a sliding window over an incoming stream. Lowering B directly increases the resolution at which the system 100 can identify the exact moment a spike occurs and thus to identify temporal relationships in the pattern. The system 100 performs correlation once it receives M indicators. The correlation is repeated in a sliding window fashion over the input stream, and every time another complete bin of B indicators per neuron is received. The example of FIG. 3 shows the binning operation over a sliding-window on incoming indicator streams with N=6, M=20, B=5, M′=M/B=4. The N×M window slides by B=5 bits every timestep. Two windows are outlined.

Template matching uses Pearson's Correlation Coefficient (PCC) to perform the correlation. PCC is a general measure of similarity between two samples X and Y of size L defined as:

$$r ( X , Y ) = \frac{{\sum }_{i = 1}^{L} ( {x}_{i} - \overline{x} ) ( {y}_{i} - \overline{y} )}{\sqrt{{\sum }_{i = 1}^{L} {( {x}_{i} - \overline{x} )}^{2}} \sqrt{{\sum }_{i = 1}^{L} {( {y}_{i} - \overline{y} )}^{2}}} , \qquad ( 1 )$$

where x is the arithmetic mean of the sample

$$\overline{x} = \frac{1}{L} {\sum }_{i = 1}^{L} {x}_{i} .$$

In template matching, the system 100 can perform the above correlation element-wise between two binned indicator matrices: the pattern matrix D and of an equally sized window W of the incoming indicator stream matrix Q. Both D and W are derived from N×M×B indicators, and after binning contain N×\hat{M} elements each of Ig (B_{Eff}) bits.

The computational and memory needs vary greatly depending on the following four parameters: N the number of neurons, the event duration M, the resolution at which activity is to be aggregated or bin size B₁ and the number of templates T. TABLE 1 identifies four example configurations of various example applications.

TABLE 1

| | N | T | M | | M | B | | GOPS/ | Memory |
|---|---|---|---|---|---|---|---|---|---|
| | neurons | templates | samples | sec | bins | samples | msec | Template | Mb |
| CFG₁ | 1K | 1 | 150 k | 5 | 20 | 7500 | 250 | 0.6 | 0.3 |
| CFG₂ | 10K | 2 | 150 k | 5 | 1000 | 150 | 5 | 314.0 | 114.4 |
| CFG₃ | 20K | 3 | 270 k | 9 | 36 | 7500 | 250 | 21.6 | 33.0 |
| CFG₄ | 30K | 4 | 270 k | 9 | 1800 | 150 | 5 | 1696.6 | 1236.0 |

The system 100 applies PCC after binning neural data with test bin sizes ranging from 5 to 250 milliseconds, with window values ranging from 1 to 9 seconds. For the purpose of stress-testing, experiments on the present embodiments used extreme values while anticipating an increase in the number of neurons simultaneously recorded as technology evolves.

For applications that involve detecting memories (e.g., traumatic events), templates representing activity of 5 to 9 seconds (M) binned over 5 to 250 msec (B) were tested in various configurations (CFG₁ to CFG₄) in example experiments (with the acquisition rate of 30 KHz). The least demanding configuration CFG₁ is representative of several state-of-the-art applications. CFG₄ is representative of future applications with 30K neurons and events of 9 seconds. The table also reports: 1) the number of arithmetic operations needed to perform Pearson's Correlation Coefficient over a single template and one window of the input as it was originally proposed, and 2) the on-chip memory needed by PCC_{BASE}. PCC_{BASE} is a particular hardware optimized implementation that uses Pearson's Correlation Coefficient. The present embodiments significantly reduce costs compared to PCC_{BASE}.

While it can be assumed, for clarity, that there are N separate incoming streams, one per neuron, a costly analog front-end signal interface that generates the indicators is typically shared over multiple, if not all neurons. As a result the analog front-end's output naturally time-multiplexes the indicators of several neurons over the same digital output serial link; as illustrated in FIG. 3. Given a relatively low acquisition rate, for example 30 KHz per neuron, a single digital serial link can easily communicate the indicators of tens of thousands of neurons. Without loss of generality, from this point it can be assumed that all N neurons can be serialized into a single batch of N binary indicators all corresponding to the same time step. B of those batches are read to form a complete bin; thus, NB serial indicators are read as a complete bin. Similarly, M bins are read to form a complete sliding window; thus, NM\hat{B} serial indicators are read as a complete sliding window.

It is understood that binning involves a reduction operation that takes a vector A of size n, and reduces A into a binned vector Â of size \hat{n}. Vector A is segmented into \hat{n} equal sub-vectors, A₀, A₁, . . . , A\hat{n}, each of size b. The binned vector Â includes the sums of these sub-vectors, namely, Â={ΣA₀, A₁, . . . , Aₙ}. Note that \hat{n}=n/b. To perform binning on a matrix, each of its rows is binned separately.

Advantageously, the system 100 can operate directly on an incoming serial indicator stream avoiding the overheads of binning and of the floating-point arithmetic used by a direct implementation of the PCC. Advantageously, the system 100 can use a decomposition of PCC into simple bit-level operations, as described herein.

In some cases, the system 100 decomposes the PCC into a series of simpler bit-level operations. The PCC between two samples X and Y (which can be represented as vectors) of length L is defined in Equation (1). Substituting the arithmetic means, squaring and rearranging the PCC equation yields:

$$r {( X , Y )}^{2} = \frac{{( L {\sum }_{i = 1}^{L} {x}_{i} {y}_{i} - {\sum }_{i = 1}^{L} {x}_{i} {\sum }_{i = 1}^{L} {y}_{i} )}^{2}}{( L {\sum }_{i = 1}^{L} {x}_{i}^{2} - {( {\sum }_{i = 1}^{L} {x}_{i} )}^{2} ) ( L {\sum }_{i = 1}^{L} {y}_{i}^{2} - {( {\sum }_{i = 1}^{L} {y}_{i} )}^{2} )} \qquad ( 2 )$$

Let D (template) and W[t] (input neural indicator stream window starting at time t) be respectively two matrices of indicators. The PCC of the binned \hat{D} and Ŵ[t] is determined by the template matching module. Before binning, D and W contain N×M×B indicators, whereas \hat{D} and Ŵ[t] contain N×M binned values where \hat{M}=M/B₁B the number of indicators per bin, N the total number of neurons, and M the per neuron sample count in indicators of the template. Let d_{n,c,b} be an element from the template matrix D and [symbol] be an element from the binned template matrix \hat{D}. Respectively, they represent the indicators and the corresponding binned indicators of the template D. Where n is a neuron (matrix row), c and ĉ are respectively columns of the pre-binned D and the binned \hat{D}, and b is the 3^{rd} dimension index of the indicator matrix D that are binned together to produce the binned values of \hat{D}. Similarly, w_{n,c,b} [t]( [symbol] [t]) refer to the corresponding elements for the current window W [t] (Ŵ[t]) matrix captured from the incoming stream.

It can be observed that the squared Pearson's Correlation Coefficient from Equation (2) can be split into constants and summations:

$${r [ t ]}^{2} = \frac{{( {C}_{1} {S}_{1} [ t ] - {C}_{2} {S}_{2} [ t ] )}^{2}}{{C}_{3} ( {C}_{1} {S}_{3} [ t ] - {{S}_{2} [ t ]}^{2} )} \qquad ( 3 )$$

where the constants are the following (all [symbol] are statically-known binned template values):

$${C}_{1} = \hat{M} N , {C}_{2} = {\sum }_{\hat{m} = 1}^{\hat{M}} {\sum }_{n = 1}^{N} , \\ {C}_{3} = \hat{M} N {\sum }_{\hat{m} = 1}^{\hat{M}} {\sum }_{n = 1}^{N} {2}^{} - {( {\sum }_{\hat{m} = 1}^{\hat{M}} {\sum }_{n = 1}^{N} )}^{2} \qquad ( 4 )$$

and the summations are:

$${S}_{1} [ t ] = {\sum }_{\hat{m} = 1}^{\hat{M}} {\sum }_{n = 1}^{N} [ t ] ( element - wise multiply - sum ) \\ {S}_{2} [ t ] = {\sum }_{\hat{m} = 1}^{\hat{M}} {\sum }_{n = 1}^{N} [ t ] ( accumulation ) \\ {S}_{3} [ t ] = {\sum }_{\hat{m} = 1}^{\hat{M}} {\sum }_{n = 1}^{N} {[ t ]}^{2} ( sum of squares ) . \qquad ( 5 )$$

The constants, hereafter referred to as Pearson's constants, are terms involving templates only (independent of the sliding indicator matrix Ŵ[t]) and, in some cases, can be predetermined (determined ‘offline’) and stored in memory, determined prior to receiving signals, or otherwise received by the network interface 160. The summations, hereafter referred to as Pearson's summations, are terms dependent on Ŵ[t] and can be generally determined by the summation module 174 at runtime, once a complete bin is received. In the present embodiments, Pearson's summations are determined by the summation module 174 based on the received bit-serial binary indicators associated with the received neuron signals.

Summation S₂ is a sum of all binned values in the incoming window. An example pseudocode algorithm for summation S₂ is described below. Since each binned value is itself a count of indicators, S₂ is a count of all N M indicators in the window. This count changes as the window slides. To avoid storing the whole window, the system 100 stores a population count per column (bin) of the sliding matrix Ŵ[t] into memory R₂ (line 6). Once the accumulation of a new column P₂ that enters to the sliding window (line 5) is completed, this column sum is added to the final S₂ sum and the column that exists the sliding window and was computed \hat{M} columns in the past (line 7) is subtracted.

ALGORITHM 1
S₂ Summation Process.

// all variables are intially zero

| | |
|---|---|
| 1 | while TRUE do |
| 2 | \| for \hat{m} = 1 to \hat{M} do |
| 3 | \| \| for b = 1 to B do |
| 4 | \| \| \| for n = 1 to N do |
| | \| \| \| \| / / timestep: (\hat{m} − 1)BN + (b − 1)N + n |
| | \| \| \| \| / / if w indicates a spike |
| | \| \| \| \| / / Increment column sum |
| 5 | \| \| \| \| P₂ ← P₂ + w; |
| | \| \| / / store current column sum to R₂ RAM |
| 6 | \| \| R₂ [symbol] ← P₂: |
| | \| \| / / add newestColumn-oldestCcolumn to S₂ |
| 7 | \| \| S₂ ← S₂ + P₂ − R₂[\hat{m}]: |
| 8 | \| \| Send a copy of current S₂ to next stage; |
| 9 | \| \| P₂ ← w ; / / clear column sum |
| 10 | \| \| [symbol] ← \hat{m} ; / / store previous \hat{m} |

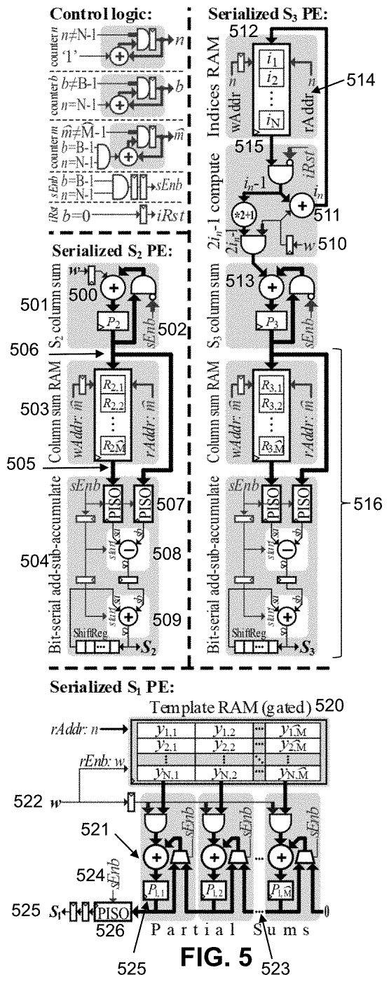

An example hardware implementation of S₂ is shown in FIG. 5 (bottom, left). The system 100 first accumulates input indicators (received serially at w 500) into S₂ column sum register (P₂) 501. The control signal sEnb 502 indicates when a column sum is ready. This happens every N \hat{M} cycles. Once a column (bin) of indicators is accumulated, the sum P₂ is moved to the column sum memory R₂ 503 and P₂ is reset to prepare it for the next column accumulation. The final stage of processing S₂ in this example is the bit-serial add-sub-accumulate 504. This block receives the new column sum 505 (to be added) from the column sum register P₂, and the oldest column sum (to be subtracted) from the column sum memory R₂[\hat{m}] 506. Both of these sums are serialized using a Parallel-Input-Serial-Output (PISO) unit 507, and the difference 508 of those sums is accumulated 509 (serially) to the final S₂ value.

Summation S₃, as shown in Equation (5), uses additional information as it accumulates the squares of the binned input. One approach is to accumulate the binned indicators and then square the accumulated value for each bin. This can generally be expensive as it has to accumulate values ahead of processing, and a cost-prohibitive squarer circuit for each bin of a total of N bins. An alternative highly-efficient approach is to break the squares into partial sums that will be generated and accumulated as new values are received. In an embodiment, the system 100 can use a sum of first odd natural numbers to break the square operation into a summation of linear operations:

$${a}^{2} = {\sum }_{i = 1}^{n} ( 2 i - 1 ) \qquad ( 6 )$$

Substituting in Equation (5) yields:

$${S}_{3} [ t ] = {\sum }_{\hat{m} = 1}^{\hat{M}} {\sum }_{n = 1}^{N} {[ t ]}^{2} = {\sum }_{\hat{m} = 1}^{\hat{M}} {\sum }_{n = 1}^{N} {\sum }_{i = 1}^{a} ( 2 i - 1 ) \qquad ( 7 )$$

Where the upper bound for a is [symbol] [t]; the corresponding binned value. Advantageously, this summation can happen ‘on-the-fly’, incrementing a every time a 1 is received. Accordingly, the system 100 does not need to know the upper bound in advance. Instead, the system 100 ‘discovers’ the upper bound as the stream is received.

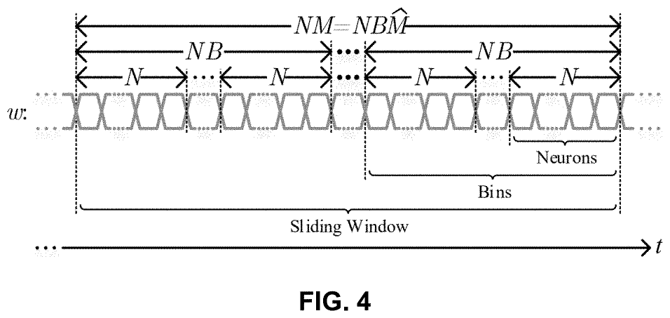

For efficiency, the summations can be organized to match the order in which the indicators are received as exemplified in FIG. 4: \hat{m} in the outer summation, bin the middle summation, and n in the inner summation, namely Σ_{ŵ=1}^{Ŵ}Σ_{b=1}^{B}Σₙ₌₁^{N}. For this purpose, the system 100 keeps the running indexes i for each element of the current column. This can be solved by storing intermediate copies of the variable i one per neuron n. An example pseudocode algorithm for summation S₃ is described below.

Algorithm 2: S₃ Summation Process.

| | // all variables are initially zero | | | | |
|---|---|---|---|---|---|
| 1 | while TRUE do | | | | |
| 2 | \| | for \hat{m} = 1 to \hat{M} do | | | |
| 3 | \| | \| | for b = 1 to B do | | |
| 4 | \| | \| | \| | for n = 1 to N do | |
| | \| | \| | \| | \| | // timestep: (\hat{m} − 1) BN + (b − 1) N + n |
| | \| | \| | \| | \| | // if first bit in bin clear sum index, otherwise increment |
| 5 | \| | \| | \| | \| | $\text{?} ← w + \{ \begin{matrix}0 & if b = 1 \\ {l}_{n} & \text{otherwise;}\end{matrix}$ |
| | \| | \| | \| | \| | // if w indicates a spike |
| | \| | \| | \| | \| | // increment sum index |
| 6 | \| | \| | \| | \|_ | P₃ ← P₃ + w(2iₙ − 1): |
| | | | \|_ | | |

| | | | |
|---|---|---|---|
| | \| | \| | // store current column sum to R₃ RAM |
| 7 | \| | \| | R [symbol] [symbol] ] ← P [symbol] |
| | \| | \| | // add newestColumn-oldestColumn to S₂ |
| 8 | \| | \| | S3 ← S3 + P [symbol] − R [symbol] [\hat{m}]; |
| 9 | \| | \| | Send a copy of current S₃ to next stage: |
| 10 | \| | \|_ | P3 ← w; // clear column sum |
| 11 | \|_ | | \hat{mₚ} ← \hat{m}; // store previous \hat{m} |

[symbol]

indicates data missing or illegible when filed

The S₃ summation process is similar to the S₂ summation process; however, a copy of the current index i of neuron n is stored into the memory location iₙ. iₙ is incremented if the spike indicator w is active, and will be cleared for every n on the first bit of each the bin (line 5). The column sum P₃ will be incremented by 2iₙ−1 if the incoming indicator w is active. This will generate the sum of squares as dictated by Equation (6).

As illustrated in FIG. 5 (top, right), the incoming indicators 510 are accumulated 511 into an indices memory 512 for each neuron of the N neurons separately; for example, iₙ for neuron n ε {1, . . . , N}. Subsequently, 2iₙ−1 is determined, and accumulated to the column sum register P₃ 513. The computation of 2nᵢ−1 is performed for each neuron separately. The control signal iRst 514 is activated every B cycles for a period of N cycle to clear the previous content of the memory 515. Note that the fragments of the squares start being accumulated before having the complete square value. The rest of the S₃ summation process 516 is similar to the S₂ summation process.

Summation S₁, as shown in Equation (5), is different than the previous two sums as it involves the template. S₁ is an element-wise multiply-sum of elements from the binned template and elements from the sliding spikes matrix. The major challenge of element-wise multiply-sum is that it requires recomputing all matrix elements for each incoming bin (a column in the matrices). Unlike S₂ and S₃, the system 100 cannot perform this summation by adding the difference between the first and the last column. However, the approach of the present embodiments simplifies this compute-intensive operation and does not require any multiplier. Instead, the system 100 uses an accumulator for each of the matrix columns by substituting the binned form of the input spikes sliding matrix 2 from Equation (5) with the serialized input w. S₁ will thereby be determined as:

$${S}_{1} [ t ] = {\sum }_{\hat{m} = 1}^{\hat{M}} {\sum }_{n = 1}^{N} {\sum }_{b = 1}^{B} \{ \begin{matrix} & if {w}_{n , \hat{m , b}} [ t ] = 1 \\ 0 & otherwise\end{matrix} \qquad ( 8 )$$

For each of the N neurons, the binned value of the template 520 is accumulated 521 if the input spike indicator w 522 is active. For example, if the incoming spike indicators stream is “ . . . 0100101” and the current bin value is x, the value of x will be accumulated three times; thus it will be multiplied by three, the number of active indicators (binary l's) in the stream. The accumulators are connected in series 523 to implement the sliding window. Once a complete bin (column) is computed (i.e., control signal sEnb 524 is asserted), its accumulated value is moved and accumulated in the neighboring accumulator. After \hat{M} successive bin accumulations, all \hat{M} bins (columns) will be accumulated in the leftmost register 525. Finally, the accumulated S₁ is serialized 526.

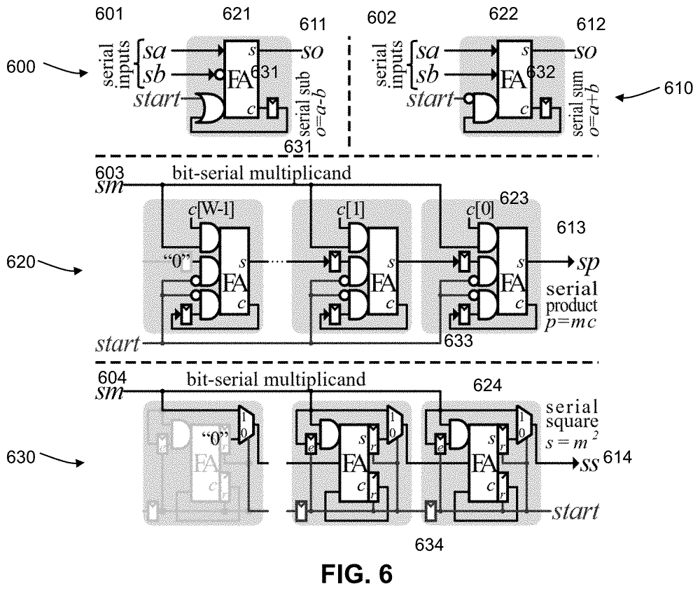

To find the Pearson's Correlation Coefficient value, the Pearson's sums, together with the pre-computed Pearson's constants, are substituted into Equation (3). This determination includes (1) a constant multiplier, (2) a subtractor, (3) a squarer, and (4) a fractional divider. In some cases, to reduce the overhead of the post-processing hardware, this determination can be implemented using bit-serial arithmetic. FIG. 6 illustrates an example of a family of bit-serial arithmetic circuits modified for the present embodiments. There is a unit latency whereby the first output bit is generated at the same cycle that the first valid bit has been received. The first valid bit propagates through a combinatorial logic to generate the first valid bit. A single register is added between each cascaded unit to break long combinatorial paths that may be created. In some cases, the constant multiplier and squarer can be modified versions of carry-save add-shift semi-systolic multipliers. While other bit-serial arithmetic circuits require a control signal to indicate the last bit of bit-serial value, the present embodiments only require indication of the first bit of the bit-serial value at the beginning of the determination. This further simplifies the design. In this case, an ultra low-area fractional divider has also been implemented.

FIG. 6 illustrates an example of a family of bit-serial arithmetic circuits. The illustrated implementation exhibits a unit latency, namely, the first output bits (611, 612, 613, and 614) are generated at the same cycle that the first valid bits (601, 602, 603, and 604) have been received. The first valid bit propagates through combinatorial logic (621, 622, 623, and 624) to generate the first valid bit. A single register (631, 632, 633, and 634) is added between each cascaded unit to break long combinatorial paths that may be created. The constant multiplier 620 and squarer 630 can be modified versions of Gnanasekaran's carry-save add-shift semi-systolic multiplier. While the aforementioned bit-serial arithmetic circuits require a control signal to indicate the last bit of bitserial value, the illustrated implementation only requires indication of the validity of the first bit (601, 602, 603, and 604) of the bit-serial value at the beginning of the computation; further simplifying the design.

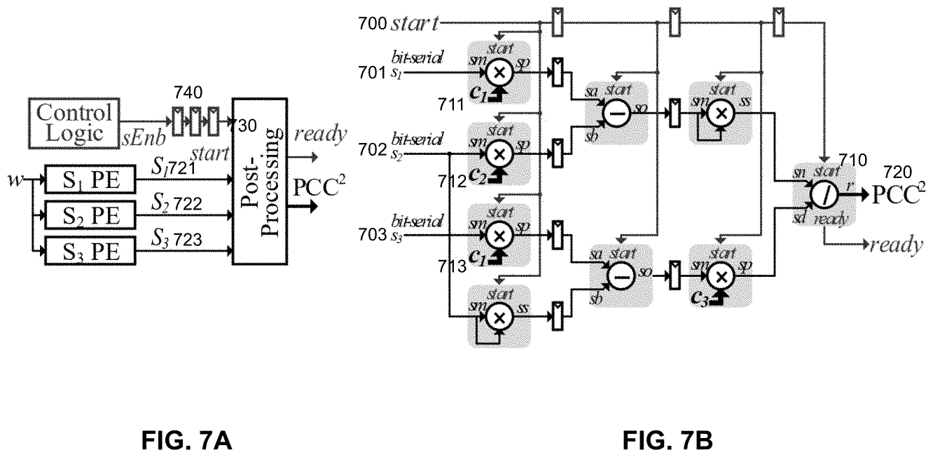

An example implementation of post-processing circuitry is exemplified in FIG. 7B. The post-processing module 176 receives bit-serial Pearson's sums, and bit-parallel Pearson's constants. Bit-serial arithmetic units, as part of the post-processing module 176, are cascaded to determine the squared PCC as formulated in Equation (3). To increase the maximum possible Fₘₐₓ, the computation can be pipelined together with the start signals that synchronize the computation start time for each unit. The computation performance and latency are dominated by the fractional divider, thus the post-processing units can process one set of inputs every WP cycles, where W is the data width and P is the precision of the output.

The post-processing unit has two major inputs, the Pearson's sums and the Pearson's constant. The Pearson's sums are generated serially by the S₁ summation process, the S₂ summation process, and the S₃ summation process. As depicted in the example of FIG. 7A, the post-processing module 176 receives those sums as bit-serial inputs, together with a control signal to start the processing. Pearson's constants can be generated offline and are loaded as bit-parallel inputs to the post-processing unit.

FIG. 7B shows an example implementation of the post-processing circuitry. The post-processing unit receives bit-serial Pearson's sums (701, 702, and 703), and bit-parallel Pearson's constants (711, 712, and 713). The bitserial arithmetic units are cascaded to compute the squared PCC 720 as formulated in Equation (3). To increase the maximum possible Fmax, the computation can be pipelined together with the start signals 700 that synchronize the computation start time for each unit. The computation performance and latency are dominated by the fractional divider 710, thus the post-processing units can process one set of inputs every WP cycles, where W is the data width and P is the precision of the output 720. The post-processing unit has two major inputs, the Pearson's sums (701, 702, and 703) and the Pearson's constant (711, 712, and 713). The Pearson's sums are generated serially by S₁ PE 721, S₂ PE 722, and S₃ PE 723. As depicted in FIG. 7A, the post-processing unit 730 receives those sums as bit-serial inputs (721, 722, and 723), together with a control signal 740, to start the processing. On the other hand, Pearson's constants can be generated offline and loaded to the post-processing unit 730.

TABLE 2 shows the cost in bits of various storage elements given a configuration. B_{eff} is an expected maximum count for the bin values. This maximum is a function of the intrinsic firing rate of the brain and of the sampling rate used by the analog front-end. It is known that the neurons fire at a maximum rate of 1 KHz, whereas a commonly used sampling rate for neuroprobes is 30 kHz. The higher sampling rate permits a resolution that is necessary for identifying when spikes occur. Accordingly, the expected maximum value for a binned value will not exceed B/30, where B is the total number of samples binned per value. An example experiment confirmed, using indicator traces from mice, that for B=150 the maximum expected value B_{eff}=5. Since most of the system's 100 memory is consumed by template memory, the system 100 advantageously can use efficient encoding of the template matrix.

TABLE 2

| Sub-module | Resource | Width | Depth |
|---|---|---|---|
| S₁ PE | Registers (P₁, PISO) | \hat{M}log₂(N\hat{M}B_{eff}²) | 1 |
| | Template RAM | \hat{M}log₂(B_{eff}) | N |
| S₂ PE | Registers (P₂, PISO, SR) | log₂(N⁴\hat{M}B_{eff}⁴) | 1 |
| | Column RAM (R₂) | log₂(NB_{eff}) | \hat{M} |
| S₃ PE | Registers (P₃, PISO, SR) | log₂(N⁴\hat{M}B_{eff}⁸) | 1 |
| | Column RAM (R₃) | log₂(NB_{eff}²) | \hat{M} |
| | Indices RAM (i) | log₂(NB_{eff}) | N |
| Post- | Registers | 80log₂(N\hat{M}B_{eff}) | 1 |
| Processing | | | |

The template memory size can, in many cases, reach hundreds of megabits. Such memory sizes are undesirable for untethered applications. Using off-chip memory is also undesirable due to its energy and latency costs compared to using on-chip SRAM. Therefore, better and/or more efficient compressing of template values is desirable.

It has been determined in example experiments that templates collected from thousands of neurons in mice exhibit a geometric distribution of values, with the frequency of low magnitude values far exceeding that of the rest. For such a distribution, unary coding is an efficient entropy lossless compression. Accordingly, for the case of B=150 (max binned value B_{Eff}=5), values 0 to 5 are encoded, respectively, as 0b, 10b, 110b, 1110b, 11110b and 11111b. However, for larger values of B, unary decoding may require large one-hot to binary decoders. Unary and binary codes can be mixed to implement a simple-to-decode variable length encoding scheme referred to as UB_{u,b} coding. A UB_{u,b} code represents a UB code with unary variable-length codes of maximum u-bits length, and a binary fixed-length code of b-bits length. For example, for B=7500 (max binned value B_{Eff}=250), a UB_{4,8} encoding can be used. That is, values up to 3 are encoded in unary, whereas larger values are encoded with a prefix of 1111b followed by the actual value v. This encoding uses 12 bits in total for all values above 3. It is understood that other possible encoding schemes can be used, where such schemes carefully balance area, complexity, energy, and compression ratio.

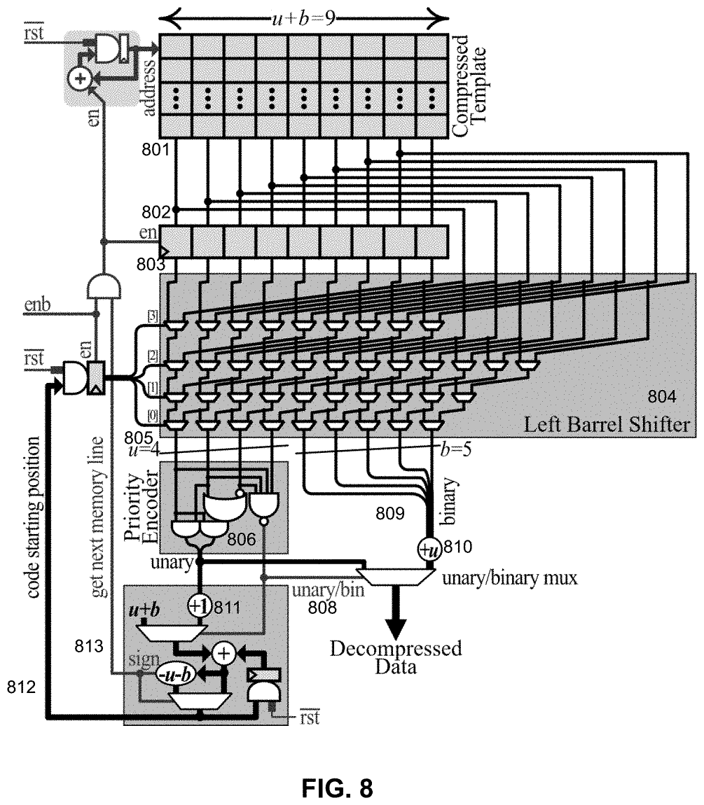

FIG. 8 illustrates an implementation for an example UB_{4,5}. To allow a single code decoding per cycle, compression of data is arranged in lines of u+b=4+5 bits width. A single line 801 is read every cycle and the previously read line 802 is stored to allow processing the remaining bits from the previous line. The previous line and the current line are packed as a double-width line 803. The core of the decompression engine is a barrel shifter 804 that allows reading the data from a specific starting position. After shifting the data, the first u+b bits are the current code. The first u-bits 805 are the unary part and are processed using a u-bits priority encoder 806 to receive the index of leading zero 807. If all u-bits are l's 808, the current code is binary; the next b-bits 809 are read from the binary code portion then u is added 810 to generate the decompressed data. Otherwise, the current code is unary; the output of the priority encoder (index of leading zero) is actually the decompressed data. The rest of the circuitry 811 shown in FIG. 8 determines the starting index 812 of the next code and generates an enable signal 813 that enables reading the next line from the memory once the remainder of the combined current and previous lines is less than u+b bits. In this implementation, one decompressor unit per template memory column is used.

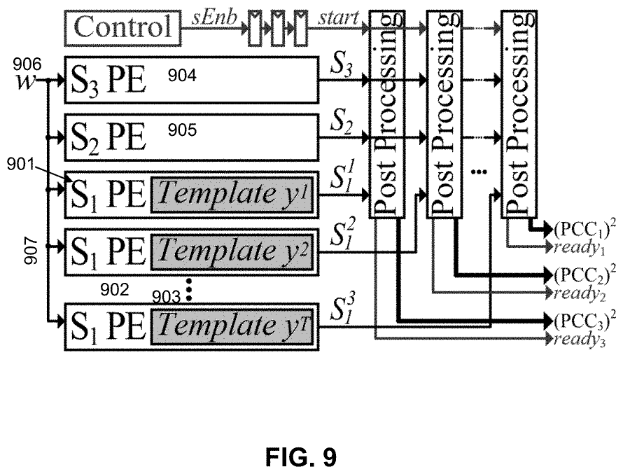

While the present disclosure has described using a single template, it is understood that multiple templates (901, 902, and 903) can be used. FIG. 9 shows an example of scaling to support multiple templates. Advantageously, summation processes S₂ 905 and S₃ 904 are functions of the input stream 906 solely. Accordingly, only the S₁ summation process 907 needs to be determined by the summation module 174.

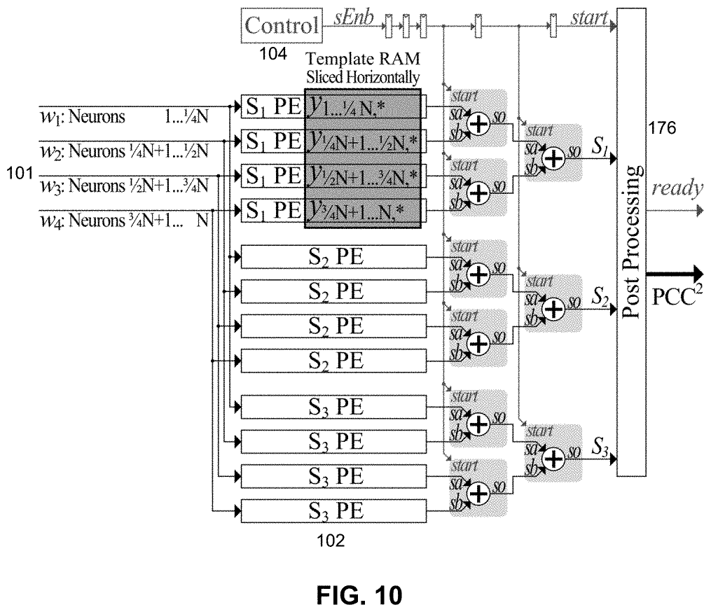

A first parameter available to scale up the number of neurons to process is operating frequency. Since the system 100 can perform the determinations at the same rate as the data is received, the frequency needs to be N×KHz to process N. To surpass the limitations of the frequency, even more neurons can be used by partitioning the input stream coupled with replication of computation components; as illustrated in the example of FIG. 10. The example shows scaling up to 4× more neurons by partitioning the input stream into four sub-streams 101, where each sub-stream is assigned its own set of summation units 102, as part of the summation module 174. The post-processing module 176 is scaled up accordingly. The costs would be linear for the replicated summation units 102, whereas they are logarithmic for the post-processing module 176. Fortunately, the template memory can be partitioned, as with the input neurons. In general, overall area of the template memory 104 will be mostly unaffected by the required partitioning. The relative cost of the processing logic in the present embodiments is generally negligible compared to the template memory.

The present approach for scaling up to more neurons opens up another configurable dimension that can be tuned to reduce operating frequency and power at a negligible increase in area. The input stream can be partitioned and thus use more processing units in order to reduce frequency and improve power efficiency. The low area needed by the computational portion allows this to be an effective approach. Advantageously, for the most demanding configurations studied in example experiments, the latency for producing the correlation output per window was only 700 cycles with a reduced clock frequency of 140 KHz; thus, the system 100 would still meet a 5 ms requirement. In some cases, by delaying the incoming stream w by one cycle, the system 100 avoids accessing the template memory when the indicator is 0. This improves energy consumption by nearly 7 times for the most demanding of configurations as the indicator stream is sparse.

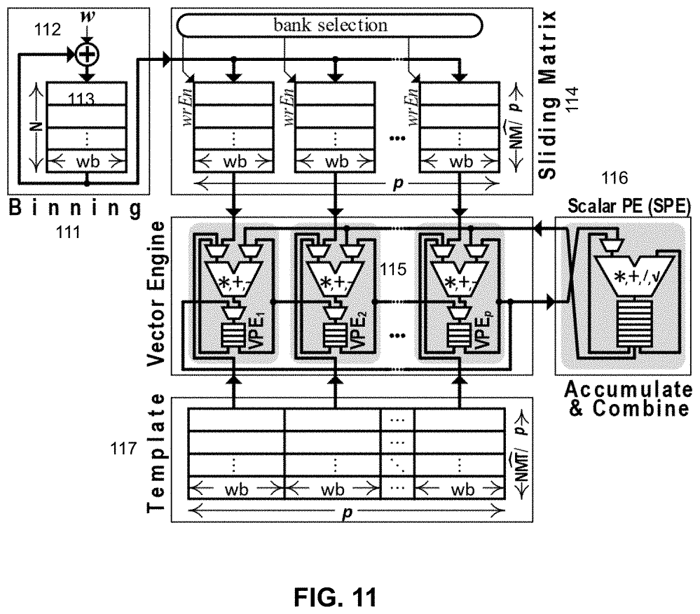

An optimized baseline vector-unit-based template post-processing module 176 can be used to determine the Pearson's Correlation Coefficient on binned values (referred to as PCC_{BASE}). As shown in FIG. 11, the binning module 178 111 can be used to convert the serialized input w 112 into corresponding bin values per neuron. After NB cycles, the binning memory 113 will include the value of the current bin for all N neurons. As the last N indicators are received, the bin values are finalized one per neuron per cycle. At that time, they are transferred (one by one) to the corresponding column in the sliding matrix unit 114 of the post-processing module. The sliding matrix unit contains N \hat{M} elements each of lg(B_{eff}) bits. Each NB cycles, the next column of the sliding matrix is selected and written to the corresponding segment. This will implement a sliding window of the binned spike indicators.

In an embodiment, a set of vector processing elements (VPEs) 115 as part of the post-processing module perform computations needed by the correlation. For this purpose, the correlation computation can be split into components that can be performed over binned columns of the input (intra-column operations), and then the per column operations can be combined to produce the final output (cross-column). The intra-column operations are computed by the VPEs 115. A scalar processing element (SPE) 116 performs the cross-column computations. Rather than allocating a VPE 115 per template 117 column, the sliding matrix can be split column-wise into p columns where p is tuned to achieve the required acceleration.

The post-processing module 176 contains T templates 117 which it matches against the incoming stream. There are N\hat{M}T elements in the template unit each having lg(B_{eff}) bits. Each column of the template matrix is thereby

$$\frac{N \hat{M} T}{p} .$$

In an embodiment, the VPEs and the SPE each contain 4×32 bit register-files for storing their intermediate results. The register-files in the VPEs are chained together to form a shift-register. This allows moving data from all VPEs' register-files for processing in SPE. The main purpose of the shifting operation is to allow accumulating column data. As a result, there are NB cycles to process the sliding matrix and generate the PCC before the next binned column arrives and contaminates the sliding matrix content. The VPEs and the SPE implement floating-point arithmetic, as operations with the incoming binned data, as per Equation (1), entail an average. In some cases, for the most demanding configuration CFG₄, single-precision may be needed as the individual sums in Equation (1) involve the accumulation and multiplication of 30,000×8,000 8-bit inputs. In other applications, and provided that the spiking rate in the input stream is known to be low, fixed-point units can be sufficient for the VPEs and the SPE.

The number of lanes p can be configured to meet the minimum required latency requirement, for example, the 5-millisecond latency requirement. By considering the latency in cycles needed per stage, the following constraint was derived:

$$5 T ( \frac{2 N \hat{M}}{p} + p ) / {F}_{max} < min ( \frac{8}{30000} , 0.005 ) \qquad ( 9 )$$

In example experiments, a maximum frequency of Fₘₐₓ=270 MHz was achieved. Accordingly, for the evaluation configurations CFG_{1 . . . 4} from TABLE 1, the number of lanes used p was 1, 201, 22, and 2,263, respectively. Each lane has a 4×32b register file to store results locally reducing overall energy in comparison to using a common, shared register file across multiple lanes.

For the example experiments, the present inventors used actual neuron indicator streams collected over 2400 seconds from 6446 neurons of three mice. For experiments requiring inputs from more neurons, these traces were augmented by sampling per neuron activity from the existing trace while maintaining the overall activity factor. The target frequency was constrained to be only as high as necessary to meet the timing requirements of each specific configuration.

The power consumption was estimated using a post-layout netlist with an activity factor of F_{t,avg}/Fₛ=1/1500. This is the ratio between the average neuron firing rate and the sampling rate, which represents the typical neural activity factor as validated by the input datasets.

Template memory dominates area for the most demanding configurations. Without template compression, the capacity needed is a function of \hat{M}, N, and B_{Eff}. However, as determined by the present inventors, compression can greatly reduce template footprints, and thus, the on-chip memory needed.

Scaling the number of templates (e.g., FIG. 9) and the number of neurons (e.g., FIG. 10) can be combined to form a configurable architecture. This configurable architecture enables a fabrication of a single device which can be configured to process several templates with different attributes, such as number of neurons (template depth), N, number of bins in a template (template width), \hat{M}, and the number of spike indicators in a bin, B.

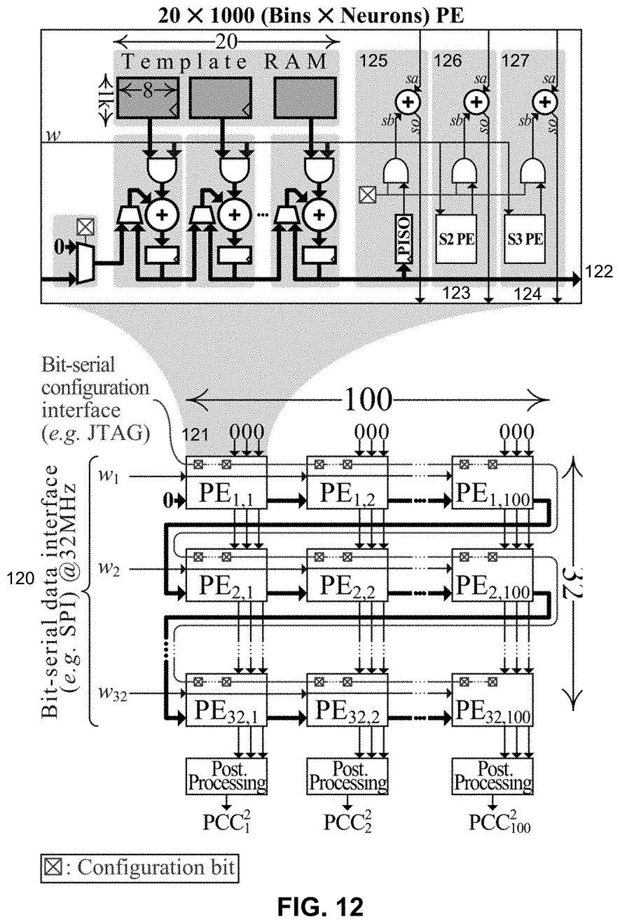

As depicted in the example shown in FIG. 12, the system 100 can receive several bit-serial inputs: w₁, . . . , w₃₂, 120 for example. Each one of those inputs is a serialization of spike indicators of several neurons. Assuming a Fₛ=30 KHz the sampling frequency, a device operating at F_{c,max}=30 MHz is capable of serializing F_{c,max}/Fₛ=1000 neurons for each bit-serial link. This is a total of 32,000 neurons for the example shown in FIG. 12.

In the example of FIG. 12, the configurable architecture is tiled, where the same processing unit 121 is replicated to enable spatial scaling. The tiles PE 121 is shown in FIG. 12 (top), and is composed of an S1 summation chain 122 as described with respect to FIG. 5 (bottom), S2 123, S3 124, and a bit-serial (125, 126, and 127) for each sum. Horizontal cascading 122 of the PEs is used to segment into several templates, where each template is a group of subsequent columns. The configuration bit CFG_{i,j}^{H} is used to control horizontal cascading 122 of PE_{i,j}. The width of S1 summation chain is used to set the template width (in bins), \hat{M}. This chain can be cut using the configuration by CFG^{H}. If the chain is cut, namely CFG^{H}=0, the current column starts a new template. Otherwise, if the chain is continued, namely CFG^{H}=1, the template is continued and the width of another PE (20 bins in the example of FIG. 12) will be added to the current template width. S2 and S3 are also calculated locally in each PE.

Vertical cascading can be used to select which neurons are used for each template. In the example of FIG. 12, a configuration bit CFGr_{i,j}^{V} can be used to control horizontal cascading of PEᵢⱼ. The three bit-serial adders (see FIG. 12 upper right corner) are used to sum up each of the sums S1, S2, and S3 in a column, among all vertical PEs. If CFG_{i,j}^{v}=0, the result PE_{i,j} is not summed up and wᵢ is not considered in the current template.

The content of the template can be used for further fine tuning if the template width. While the width of the S1 chain in a single PE is fixed (20 elements in the example of FIG. 12). It can still be reduced by zeroing the template RAM of a single element in the chain. This will select a single element from the summation chain (resulting in 19 elements in the example of FIG. 12). The operating frequency can also be used to fine tune the number of neurons. Since, in this example, the sampling frequency is Fₛ=30 KHz, and the computation is performed at the same rate as the data is received, changing the operating frequency will allow tuning the number of neurons received by each channel wᵢ, more precisely; the number of neurons received by a single link is F_{c,max}/Fₛ. The system 100 can be configured using a bit-serial configuration chain (shift register), such as a JTAG (Joint Test Action Group) interface. The configuration bits are loaded serially. The template memory can also be loaded using the same configuration chain. TABLE 3 provides a list of sample configurations, assuming the design dimensions in FIG. 12.

TABLE 3

| Configuration | N | \hat{M} | B | T |
|---|---|---|---|---|
| 1 | Up to 32 k | Up to 2 k | Up to 7.5 k | 1 |
| 2 | Up to 16 k | Up to 4 k | Up to 7.5 k | 1 |
| 3 | Up to 8 k | Up to 8 k | Up to 7.5 k | 1 |
| 4 | Up to 4 k | Up to 16 k | Up to 7.5 k | 1 |
| 5 | Up to 2 k | Up to 32 k | Up to 7.5 k | 1 |
| 6 | Up to 1 k | Up to 64 k | Up to 7.5 k | 1 |
| 7 | Up to 32 k | Up to 20 | Up to 7.5 k | 100 |
| 8 | Up to 32 k | Up to 40 | Up to 7.5 k | 50 |
| 9 | Up to 32 k | Upto 100 | Up to 7.5 k | 20 |
| 10 | Up to 32 k | Up to 20 | Up to 7.5 k | 30 |
| | Up to 32 k | Up to 40 | Up to 7.5 k | 10 |
| | Up to 32 k | Up to 10 | Up to 7.5 k | 10 |

Selecting a subset of neurons can use a suitable brain probe. For example, the brain probe can be used to detect spikes from neurons that are not related to the detected activity. Also, the probe may pass through inactive area of the brain where neural spikes are not detected. Only neurons that are related to the detected activity and contribute to the matching operation can be considered; where all other neurons should be excluded.

In a particular case, selection can use N, whereby the number of neurons that are processed is user-programmable. The user may choose to send only those neurons that contribute to the matching operation to be processed and thus configured to process those N neurons. This may require an external device to select and serialize a subset of probe neurons.

In another case, a neuron-select binary table, S₁ can be used. For each possible neuron, S stores whether this neuron is considered for the matching operation. Given a neuron id, i<Nₘₐₓ, S[i]=1 if neuron i is considered for the matching operation, otherwise S[i]=0. The binary values of S are used to enable or disable the processing circuitry. As the neuron spike activities are received serially and cyclically every Nₘₐₓ timesteps, S is read sequentially and cyclically every timestep to generate the enable/disable binary indicator for the matching circuitry. Where Nₘₐₓ denotes the maximum number of neurons that can be processed, while 01≤N<Nₘₐₓ denotes the actual number of proceed neurons.

In another case, to process a single template, S stores a selection bit for every neuron, thus the size of S is T×Nₘₐₓ bits, where T denotes the number of matched templates. For a large number of processed templates and a large number of neurons the size of S can be substantial. For instance, S consumes 120 Kbits if T=4 and Nₘₐₓ=30,000. Instead, S can be compressed based on the distribution of the selected neurons. For example, if N<<Nₘₐₓ, a sorted list of the selected neuron ids can be stored instead of a selection binary indicator for each neuron. As the size of a neuron id is log 2(Nₘₐₓ) bits, the size of the compressed table would be T×N×log 2(Nₘₐₓ). For instance, the size of the compressed S would be 6 Kbits, if T=4, N=100, and Nₘₐₓ=30,000. Similar to above, every timestep a subsequent value of the compressed S is read and compared to the id of the currently processed neurons, if they match then the current neuron is included in the matching operation and the matching circuitry is enabled, otherwise the current neuron is excluded and the matching circuitry is disabled.

In another case, a pre-filtering stage can be used to reduce the number of streamed neurons from Nₘₐₓ down to N. Similar to above, a neuron-selection table can be used (either compressed or non-compressed). This table is read subsequently and cyclically every timestep to control the filtering operation. The neuron-selection value determines whether to stream a specific neuron spike, or to exclude it otherwise.

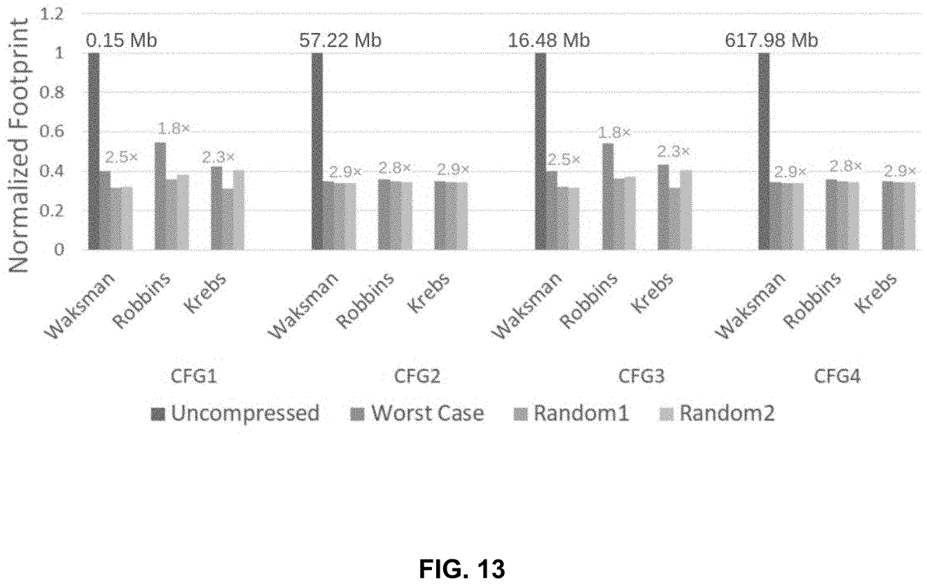

FIG. 13 illustrates determined memory footprints in the example experiments for the four configurations of TABLE 1 and different templates with and without template compression. All footprints are normalized to the footprint of the uncompressed template per configuration. Results are shown for three different templates per input sample trace; a worst case which is the frame from the neuron recording with the least sparsity, and two templates which were randomly selected windows. The worst case template dictates the compression ratio used to size the on-chip template memory. As expected, uncompressed footprint templates vary considerably, from 150 Kb for CFG₁ to more than 600 Mb for CFG₄. The lightweight lossless compression method is effective in reducing footprints, and more so where it matters the most. That is for CFG₂ (B=150, \hat{M}=1000) and CGF₄ (B=150, \hat{M}=1800) configurations where footprints are reduced by at least 2.79× for all templates. The resulting template memory sizes are shown in TABLE 4. TABLE 4 also reports the number of bits used by the various registers per unit in an embodiment of the system 100 and the total on-chip memory needed by PCC_{BASE}. While PCC_{BASE} can benefit from template compression for its own template memory, it still needs a window memory for the incoming indicator streams. As shown, the ASIC implementation of the system 100 meets real-time requirements for all configurations and, as expected, requires considerably less power than the FPGA implementation.

TABLE 4

| | | | | | | | | | PCCBASE | | |
|---|---|---|---|---|---|---|---|---|---|---|---|
| | System 100 | | | | | | | | | Template | |
| | S1 PE | | S2 PE | | S3 PE | | | | | RAM | |
| | | Tmpl | | Col. | | Col. | Idx. | PP | Sliding | Uncom- | Com- |
| | Reg | RAM | Reg | RAM | Reg | RAM | RAM | Reg | RAM | pressed | pressed |
| | (Kb) | (Mb) | (b) | (Kb) | (b) | (Kb) | (Kb) | (Kb) | (Mb) | (Mb) | (Mb) |
| CFG₁ | 0.6 | 0.08 | 77 | 0.35 | 108 | 0.51 | 7.81 | 1.7 | 0.15 | 0.15 | 0.08 |
| CFG₂ | 27.3 | 31.10 | 73 | 15.63 | 82 | 17.58 | 29.30 | 2.0 | 57.22 | 57.22 | 31.10 |
| CFG₃ | 1.3 | 5.89 | 95 | 0.81 | 127 | 1.09 | 156.25 | 2.2 | 16.48 | 16.48 | 5.89 |
| CFG₄ | 53.3 | 220.70 | 80 | 31.64 | 89 | 35.16 | 87.89 | 2.2 | 617.98 | 617.98 | 220.70 |

TABLE 5 illustrates the performance of the system 100 and PCC_{BASE} in the example experiments in terms of throughput (number of correlations computed per second) and latency (time from arrival of last data bit to complete computation) for the four configurations. For CFG₂ through CFG₄, three partitions are used, each processing ⅓ of the neurons. The present embodiments are shown to far exceed the real-time latency requirements, as it requires just 700 cycles to produce its output once the last indicator for a window is received.

TABLE 5

| | Throughput | | | | | | | |
|---|---|---|---|---|---|---|---|---|
| | (PCC/sec) | | | | Detection Latency (msec) | | | |
| CFG | 1 | 2 | 3 | 4 | 1 | 2 | 3 | 4 |
| PCCBASE | 4 | 400 | 12 | 800 | 0.74 | 4.98 | 4.71 | 5.00 |
| System 100 | 4 | 400 | 12 | 800 | 0.0239 | 0.0028 | 0.0015 | 0.001 |

TABLE 6 shows the power usage of the system 100 and PCC_{BASE} for the example experiments for the four configurations, including a breakdown in memory and compute. The system's 100 power is considerably lower than that of PCC_{BASE} for all configurations for at least three reasons: 1) the system 100 does not need a sliding window memory, 2) the compute units are much more energy efficient, and 3) the system 100 can avoid accessing the template memory when a bit indicator is 0 (most will be 0 due to the nature of brain activity). In PCC_{BASE} compute units are responsible for a significant fraction of overall power for all configurations, and this is not the case for the system 100.

TABLE 6

| | PCCBASE | | | System 100 | | |
|---|---|---|---|---|---|---|
| | Memory | Compute | Total | Memory | Compute | Total |
| CFG₁ | 7.87 | 17.34 | 25.22 | 0.30 | 0.43 | 0.73 |
| CFG₂ | 1236.74 | 607.29 | 1844.03 | 89.78 | 84.28 | 174.06 |
| CFG₃ | 198.94 | 81.12 | 280.06 | 18.55 | 9.68 | 28.23 |
| CFG₄ | 10718.07 | 6550.65 | 17268.72 | 682.70 | 522.76 | 1205.46 |

TABLE 7 shows the area in mm² for the system 100 and PCC_{BASE} as configured to meet real-time requirements of the four configurations. TABLE 7 also shows a breakdown in the area used for memory and compute component. The system 100 is considerably smaller than PCC_{BASE}. Since it uses template compression, the savings with the system 100 are due to, at least: 1) eliminating the sliding window memory, and 2) using much smaller bit-serial compute units. For the CFG₄ configuration, the system 100 is nearly 2.6× smaller than PCC_{BASE}. SRAM cells in a 14 nm process can be 6× to 8× smaller compared to 65 nm.

TABLE 7

| | PCCBASE | | | System 100 | | |
|---|---|---|---|---|---|---|
| | Memory | Compute | Total | Memory | Compute | Total |
| CFG₁ | 0.38 | 0.15 | 0.53 | 0.10 | 0.02 | 0.11 |
| CFG₂ | 81.50 | 5.87 | 87.37 | 28.46 | 1.35 | 29.81 |
| CFG₃ | 15.60 | 0.77 | 16.37 | 6.26 | 0.09 | 6.25 |
| CFG₄ | 469.42 | 63.48 | 532.90 | 202.00 | 3.42 | 205.42 |

In the example experiments, the system 100 was implemented on a Stratix 10 FPGA. TABLE 8 reports the resulting power, the Fmax achieved, and the minimum Fmax (Target) required to meet the real-time requirements of each configuration.

TABLE 8

| | Fₘₐₓ (MHz) | | Power (mW) | | |
|---|---|---|---|---|---|
| | Achieved | Target | Static | Dynamic | Total |
| CFG₁ | 467.51 | 30 | 5850.08 | 54.04 | 5904.12 |
| CFG₂ | 318.47 | 300 | 5860.47 | 1016.38 | 6876.85 |
| CFG₃ | 324.78 | 600 | 5851.42 | 495.03 | 6346.45 |
| CFG₄ | 258.53 | 900 | 5889.82 | 12014.81 | 17904.63 |

In the example experiments, software implementations of the system 100 were implemented on a CPU and a GPU. The CPU implementation uses a software pipeline to perform the binning and PCC calculations. Three GPU implementations were evaluated. The first was a hand-tuned implementation utilizing the same PCC decomposition and optimizations in the CPU pipeline. This performed the best for small configurations (e.g., CFG₁). The second implementation utilizes a Thrust (v1.8.3) library, which outperforms the hand-tuned version for larger configurations (CFG₂₋₄). The last solution used a Fast-GPU-PCC algorithm which converts PCC computation into a matrix multiplication problem. The parameters are emulated by substituting the number of voxels for neurons, and the length of time for the number of bins. The results are summarized in TABLE 9.

TABLE 9

| Device | CFG₁ | CFG₂ | CFG₃ | CFG₄ |
|---|---|---|---|---|
| CPU | 613 | 1455 | 12240 | 112952 |
| GPU-Manual | 0.28 | 26.67 | 5.36 | 274.1 |
| GPU-Thrust | 1.20 | 4.27 | 3.96 | 20.6 |
| GPU-Fast-GPU-PCC | 167.2 | 619.9 | 522.2 | 11395 |

As discussed, Pearson's Correlation generally requires storing the templates and a correspondingly large window of the input incoming stream. These matrices are costly. For example, they can grow to 1.24 gigabytes each. The computation needs also grow and reach 1.6 Tensor operations per second (TOPs), most in FP32, for larger configurations. Thus,

Computation latency is a significant challenge in the art as the computation per window has to be completed within strict constraints; for example, within 5 milliseconds. Embodiments of the present disclosure advantageously formulate the computation so that the input streams are consumed as they are received, bit-by-bit; thus, obviating the need for buffering the input. The present embodiments, accordingly, greatly reduce memory requirements, and allow the system 100 to meet real-time response times because very little computation is left after a window's worth of input is received. The formulation of the present embodiments enables the use of relatively small bit-serial units for performing the majority of the computation. The present embodiments replicate and place these units near template memory banks (i.e., near memory compute). This enables high data parallel processing and scaling at low cost. Additionally, the present embodiments use a hierarchical, tree-like arrangement of the compute units; where floating point and expensive operations are needed sparingly. Further advantageously, embodiments of the present disclosure exploit sparsity of the template content via light-weight, hardware friendly decompression units; which are replicated per bank. In some cases, templates can be compressed in advance. Since the inputs are processed a bit a time and given that the input stream is sparse, the system 100 can reduce accesses to the template memory, and thus, greatly reduce power requirements.

In some embodiments of the present disclosure, a machine learning module 182 can train an artificial neural network to approximate the behaviour of template matching using PCC. This approach enables the use of neural network hardware accelerators to implement PCC template matching for real time applications. Using a supervised neural network, training involves utilizing labelled data, where the training algorithm uses the labels to determine the correctness of the model on each iteration. In this case, the input to the neural network is a window of neuron activations, while the labels could be, for example, 1 where a window and template pair give a strong correlation (e.g., PCC>0.8) and ‘0’ elsewhere. Knowledge distillation improves upon this by using the actual PCC formula to provide more detail to the training algorithm. More specifically, the loss function can be determined using the difference between the calculated PCC and the output of the neural network. The network can simultaneously ‘learn’ multiple templates by making the output a T-dimensional vector, where each value in the vector corresponds to the PCC of the input window and the T templates. The neuron activations are binned before being passed to the network, although the binning operation may also be subsumed into the network. In an example experiment, the parameters used to generate the training data are; B=300, \hat{M}=50, N=100, T=3. Model accuracy can be shown by posing the problem as a binary classification task, where the model indicates if a strong correlation exists. The accuracy of this model is reported in TABLE 10.

TABLE 10

| Epoch | Loss | TP | FP | TN | FN |
|---|---|---|---|---|---|
| 0 | 5.095 | 120 | 13 | 12155 | 0 |
| 1 | 0.724 | 133 | 0 | 12155 | 0 |

P (Positive) indicates that the PCC formula calculated a strong correlation while T (True) indicates that the neural network outputted the correct result. In this case, the model needed just two epochs in order to correctly classify all of the windows in the dataset. This model consists of two fully connected layers with the ReLU activation function. The input dimension is given by the size of the input window (\hat{M}×N) and the output is T=3. The inner dimension is selected to be 128 for this experiment. The memory and computational demands of this model are given in TABLE 11 in terms of number of parameters and number of OPs.

TABLE 11

| Layer | # Parameters | # OPs |
|---|---|---|
| FC 1 | 640,128 | 1,280,000 |
| FC 2 | 387 | 768 |

Advantageously, this approach enables the PCC template matching technique to be efficiently mapped to existing hardware architectures which accelerate neural networks.

The present embodiments can also be generalized to enable the artificial neural network to learn other outcomes of interest. In such scenarios, the model learns to relate the spike data to a scalar or vector output, similar to the PCC coefficient(s) described previously. In some cases, a front-end can be used for selectively filtering neurons which contribute to the outcome of interest. This front-end may also bin the incoming spike data to allow the neural network to operate on binned values, but the network can alternatively be trained to operate on binary values. Processing of this implementation can include systolic arrays or vector processors to perform many operations in parallel. Inputs and outputs can be passed to and from the PU 152 while intermediate values and neural network weight values can be stored on-chip. The architecture described here requires less than 1 MB of on-chip memory to store both weights and intermediate values, though support to enable sets of weights and intermediate outputs to be loaded and unloaded sequentially may be added to facilitate larger networks. The PU 152 can be used to control the compute processors and perform other simple operations such as applying an activation function. In order to enable real-time processing, the machine learning module 182 should be capable of performing all required memory accesses and numerical operations in under, for example, 5 ms. The input on each inference is a new bin for every neuron, equating to 20 kB/s bandwidth. With a 1 MHz processor clock, 128 multiply-accumulate units can perform the necessary computations to produce a single output.

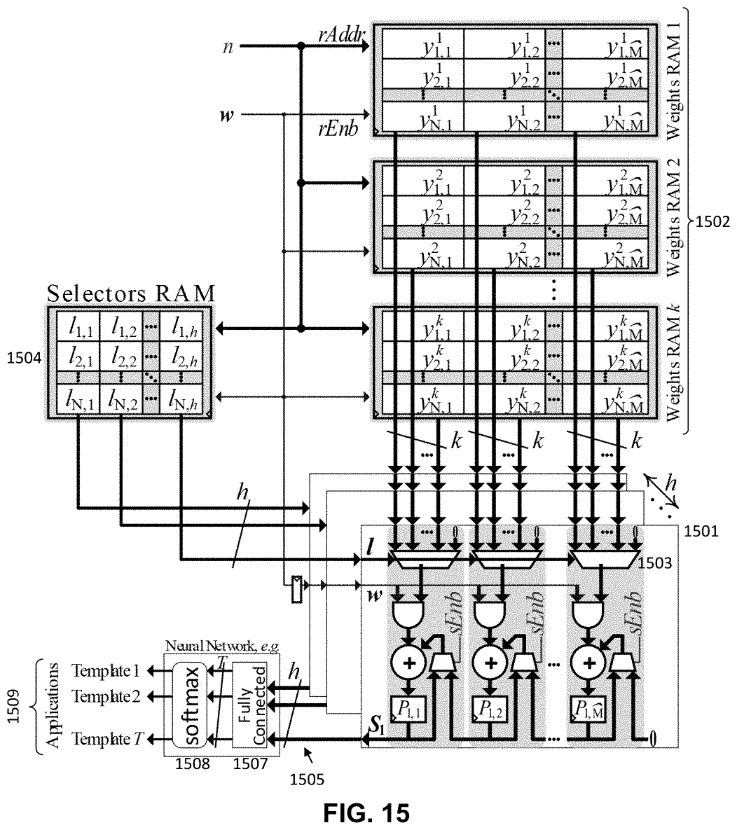

The artificial neural network described above generally operates on a window of \hat{M}×N neural activations, which uses binning and buffering, followed by a fully connected layer. In some cases, this may elevate the memory and compute requirements. The first summation (S₁), as shown in Equation (5) and implemented in FIG. 5, implements an element-wise multiply-sum operation (dot product), which can efficiently compute the first fully connected layer without the binning and buffering overheads. FIG. 15 illustrates an example implementation of the present embodiments that benefits from the efficient implementation of S₁ in FIG. 5 to implement a neural network that operates directly on a stream of serialized spike indicators, w. As each perceptron in the network is a dot product, it can be implemented using the first summation (S₁). Similar to the other neural network approaches described herein. The \hat{M}×N input window is reduced into an h-dimensional vector using h perceptrons, as illustrated in block 1501. This uses h copies of S₁. A sparsity hyperparameter, k, denotes that each neuron in the input window (M×N) may be forwarded to k perceptrons at most (out of h). In order to do so, k memory blocks are stored for weights (instead of storing templates). A multiplexing layer shown in block 1503 is used to select the weights. As shown in block 1504, a selectors memory is used to store weight selectors. The outputs of the S₁ summation units create an h-dimensional vector, as shown at 1505, that can be forwarded to additional neural network layers (such as the fully connected layer at block 1507 followed by a softmax unit at block 1508) that generate T probabilities to indicate the matching likelihood of each template, as shown at 1509.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

1. A system for template matching for neural population pattern detection, the system in communication with a plurality of neural signal acquisition circuits, the system comprising one or more processors and one or more memory units in communication with the one or more processors, the one or more processors configured to execute:
a signal interface to receive neuron signal streams from the neural signal acquisition circuits and serially associate a bit indicator with spikes from each neuron signal stream;
a summation module to serially determine a first summation (S₁), a second summation (S₂), and a third summation (S₃) on the received neuron signals, the first summation comprising an element-wise multiply-sum using a time-dependent sliding indicator window on the received neuron signal streams and a template, the second summation comprising an accumulation using the time-dependent sliding indicator window, and the third summation comprising a sum of squares using the time-dependent sliding indicator window;
post-processing module to determine a Pearson's Correlation Coefficient (PCC) value associated with a match of the template with the received neural signal streams, the PCC value determined by combining the first summation, the second summation, and the third summation with predetermined constants associated with the template; and
an output module to output the determined PCC value.

2. The system of claim 1, wherein the template is encoded using unary coding.

3. The system of claim 1, wherein the PCC value is determined only over a subset of the received neuron signal streams.

4. The system of claim 1, wherein the predetermined constants comprise:
a first constant (C₁) using a number of bins and the number of neuron signal streams;
a second constant (C₂) using binned indicators of the template summed over the number of bins and the number of neuron signal streams; and
a third constant (C₃) using a combination of binned indicators of the template summed over the number of bins and the number of neuron signal streams.

5. The system of claim 4, wherein the combination of the first summation, the second summation, and the third summation with the predetermined constants comprises a constant multiplier, a subtractor, a squarer, and a fractional divider.

6. The system of claim 4, wherein the combination of the first summation, the second summation, and the third summation with the predetermined constants comprises determining the combination (r) as a function of time (t) as:
$${r [ t ]}^{2} = \frac{{( {C}_{1} {S}_{1} [ t ] - {C}_{2} {S}_{2} [ t ] )}^{2}}{{C}_{3} ( {C}_{1} {S}_{3} [ t ] - {{S}_{2} [ t ]}^{2} )}$$

7. The system of claim 1, wherein for each of the neuron signal streams, a binned value of the template is accumulated if an input spike indicator is active.

8. The system of claim 1, wherein the post-processing module comprises bit-serial arithmetic units that are cascaded to determine a squared PCC.

9. The system of claim 1, wherein the second summation comprises a count of all bit indicators in each time-dependent sliding indicator window.

10. The system of claim 1, wherein the third summation comprises partial sums of linear operations that are generated and accumulated as new values are received.

11. A processor-implemented method for template matching for neural population pattern detection, the method comprising:
receiving neuron signal streams and serially associating a bit indicator with spikes from each neuron signal stream;
serially determining a first summation (S₁), a second summation (S₂), and a third summation (S₃) on the received neuron signals, the first summation comprising an element-wise multiply-sum using a time-dependent sliding indicator window on the received neuron signal streams and a template, the second summation comprising an accumulation using the time-dependent sliding indicator window, and the third summation comprising a sum of squares using the time-dependent sliding indicator window;
determining a Pearson's Correlation Coefficient (PCC) value associated with a match of the template with the received neural signal streams, the PCC value determined by combining the first summation, the second summation, and the third summation with predetermined constants associated with the template; and
outputting the determined PCC value.

12. The method of claim 11, wherein the predetermined constants comprise:
a first constant (C₁) using a number of bins and the number of neuron signal streams;
a second constant (C₂) using binned indicators of the template summed over the number of bins and the number of neuron signal streams; and
a third constant (C₃) using a combination of binned indicators of the template summed over the number of bins and the number of neuron signal streams.

13. The method of claim 12, wherein the combination of the first summation, the second summation, and the third summation with the predetermined constants comprises a constant multiplier, a subtractor, a squarer, and a fractional divider.

14. The method of claim 12, wherein the combination of the first summation, the second summation, and the third summation with the predetermined constants comprises determining the combination (r) as a function of time (t) as:
$${r [ t ]}^{2} = \frac{{( {C}_{1} {S}_{1} [ t ] - {C}_{2} {S}_{2} [ t ] )}^{2}}{{C}_{3} ( {C}_{1} {S}_{3} [ t ] - {{S}_{2} [ t ]}^{2} )}$$

15. The method of claim 11, wherein for each of the neuron signal streams, a binned value of the template is accumulated if an input spike indicator is active.

16. The method of claim 11, wherein the post-processing module comprises bit-serial arithmetic units that are cascaded to determine a squared PCC.

17. The method of claim 11, wherein the second summation comprises a count of all bit indicators in each time-dependent sliding indicator window.

18. The method of claim 11, wherein the third summation comprises partial sums of linear operations that are generated and accumulated as new values are received.

19. A processor-implemented method for template matching for neural population pattern detection, the method comprising:
receiving neuron signal streams and serially associating a bit indicator with spikes from each neuron signal stream;
determining a correlation value associated with a match of a template with the received neural signal streams using an artificial neural network trained using binary classification, the input to the artificial neural network comprising a window of the bit indicators, a loss function associated with the artificial neural network comprises a difference between a calculated correlation value and an output of the artificial neural network; and
outputting the determined correlation value.

20. A processor-implemented method for template matching for neural population pattern detection, the method comprising:
receiving neuron signal streams and serially associating a bit indicator with spikes from each neuron signal stream;
determining a first summation (S₁) on each of the received neuron signals and outputting the summations as a vector, the first summation comprising an element-wise multiply-sum using a time-dependent sliding indicator window on the received neuron signal streams and a template;
determining a likelihood of a match of a template with the received neural signal streams using an artificial neural network, the input to the artificial neural network comprising the vector of first summations, where each vector acts as a perceptron of the artificial neural network, and is passed to further artificial neural network layers; and
outputting the determined likelihood of match.
